(19) United States
(12) Patent Application Publication
(10) Pub. No.: US 2014/0230754 A1
(43) Pub. Date: Aug. 21, 2014

(54) Dog Garment

(71) Applicant: Lindsey J. McGraw, South Amboy, NJ (US)

(72) Inventor: Lindsey J. McGraw, South Amboy, NJ (US)

(21) Appl. No.: 14/185,895

(22) Filed: Feb. 20, 2014

Related U.S. Application Data
(60) Provisional application No. 61/767,132, filed on Feb. 20, 2013.

(51) Int. Cl. A01K 13/00

(52) U.S. Cl. CPC A01K 13/006
USPC 119/855

(57) ABSTRACT

A dog garment for retaining body heat comprises a tubular neck portion for slipping over a dog's head, a torso portion and an anchoring portion, each including heat-retentive material. The torso portion depends downwardly from the neck portion and extends posteriorly on the dog to an anchoring portion that surrounds the sides of a rib cage of the dog in the posterior section of the dog's rib cage. The torso portion has a chest covering and an intermediate portion situated between the chest covering and the anchoring portion. In the region on the back and sides of the dog, between the neck portion and the anchoring portion, the garment is sufficiently free of material so that the garment can be secured to the dog when the dog is wearing a typical harness without interfering with operation of the harness.

### CROSS-REFERENCE TO RELATED APPLICATIONS

This application claims priority to U.S. Provisional Patent Application No. 61/767,132 filed on Feb. 20, 2013, the disclosure of which is fully incorporated herein by reference.

### FIELD OF THE INVENTION

The present invention relates to a heat-retentive garment for a dog.

### BACKGROUND OF THE INVENTION

It is known that dogs lose substantial body heat in the region of their chests proximate to the heart and lungs. Although dogs have a natural coat of fur to protect against heat loss, not all dogs are equally suited for cold climates. This is especially true for dogs that are not bred for cold climates with thick fur and an undercoat.

Additionally, even if a dog is physiologically adapted for cold climates, a dog may still be harmed by contact with surface areas in forested, mountainous or the like terrain due to contact with underbrush or the like along their chest and abdominal regions.

Additionally, it is known that throat and vocal cords of dogs are adversely affected by cold climate. It is also believed that the complex system of intermingled small arteries and veins in the carotid sinus at the base of a dog's neck, which is responsible for regulating the temperature of a dog's head, is likewise adversely affected by cold climate. Although there are neck-warmers for greyhounds in the market, Applicant believes there are no products that feature a combination chest and neck covering.

Additionally, most garments for dogs in the form of coats cover either the back and chest or primarily the back and are difficult to place on a dog. These dog coats usually have a fastening mechanism that connects at the dog's abdomen, which is a difficult position for humans to reach. Dog coats that cover both the back and abdomen regions of a dog are also difficult to place on a dog because they usually require tedious manipulation of the dog's front and rear legs through sleeves.

Additionally, some dog coats only cover the front-chest region of a dog and not the lateral sides of the upper-chest, allowing for cold air to seep in under the coat toward a central part of the dog's chest.

Additionally, some dog coats extend to an area near the dog's pubic region, which may interfere with the dog's urination or may become soiled as the dog urinates.

Finally, most traditional dog coats cover a large portion of the upper-back and are not designed to be worn over a dog harness, and therefore would interfere with use of a dog harness. A typical dog harness is of the type having a first strap means anterior and proximate to a dog's front legs and a second strap means posterior and proximate to the dog's front legs. The first and second strap means are directly or indirectly connected to a restraining device mounted on the dog's back that restrains movement of the dog.

Therefore, it would be desirable to provide a dog garment (1) that has heat-retentive and abrasion-resistant qualities and that overlies areas of the neck, chest and abdomen, (2) that is easy to secure onto, and to remove from, the body of the dog, and (3) that does not interfere with a typical dog harness.

### BRIEF SUMMARY OF THE INVENTION

In a preferred form, the inventive dog garment for retaining body heat comprises a tubular neck portion, a torso portion and an anchoring portion. The tubular neck portion has a sleeve-like opening and upper and lower ends. The sleeve-like portion is large enough to slide over a dog's head. The lower end of the neck portion is sized sufficiently small so as to be restricted from sliding posteriorly on the dog due to increasing girth of the dog proximate the base of the neck in the posterior direction. The torso portion depends downwardly from the neck portion and extends posteriorly on the dog to an anchoring portion that surrounds the sides of a rib cage of the dog in the posterior section of the dog's rib cage. The anchoring portion includes a pair of cooperating straps respectively extending upwardly along the sides of the dog to a device on the back of the dog for securing the straps together. The torso portion has a chest covering depending downwardly from the neck portion to a common vertical distance from the neck portion and an intermediate portion situated between the chest covering and the anchoring portion. The neck, torso and anchoring portions include heat-retentive textile material. In the region on the back and sides of the dog, between the neck portion and the anchoring portion, the garment is sufficiently free of material so that the garment can be secured to the dog when the dog is wearing a harness without interfering with operation of the harness, wherein the harness is of the type having first strap means anterior and proximate to the dog's front legs and second strap means posterior and proximate to the dog's front legs, wherein the first and second strap means are directly or indirectly connected to a restraining device mounted on the dog's back that restrains movement of the dog.

Beneficially, the foregoing dog garment can provide one or more advantages of being heat-retentive, having abrasion-resistant qualities, of being easy to secure onto, easy to remove from a dog, and of not interfering with operation of a typical dog harness.

### BRIEF DESCRIPTION OF THE DRAWINGS

Further features and advantages of the invention will become apparent from reading the following detailed description in conjunction with the following drawings, in which like reference numbers refer to like parts:

FIG. 1 is a side-and-front perspective view of a dog wearing a dog garment in accordance with the present invention.

FIG. 2 is a perspective view of the bottom of the dog garment of FIG. 1, with cross-hatching and stippling shown on respective parts to indicate attachment means.

FIG. 3 is a top view of the dog and dog garment of FIG. 1.

FIG. 4 is a partial side view of the dog and dog garment of FIG. 1 showing a preferred relation between the posterior section of the dog's rib cage, only the posterior section of which is shown, and an anchoring portion of the dog garment.

FIG. 5 is a side view of the dog and dog garment of FIG. 1, but also showing the dog garment overlying a typical dog harness.

FIG. 6 is a top view of the neck portion and depending chest covering of the dog garment of FIG. 1.

FIG. 7 shows an enlarged detail view of a lower section of the neck portion and adjoining chest covering of the dog garment of FIG. 1, and is taken from the perspective of the arrows marked FIG. 7 in FIG. 6.

FIG. 8 shows a front view of the dog and dog garment of FIG. 1.

### DETAILED DESCRIPTION OF PREFERRED EMBODIMENTS

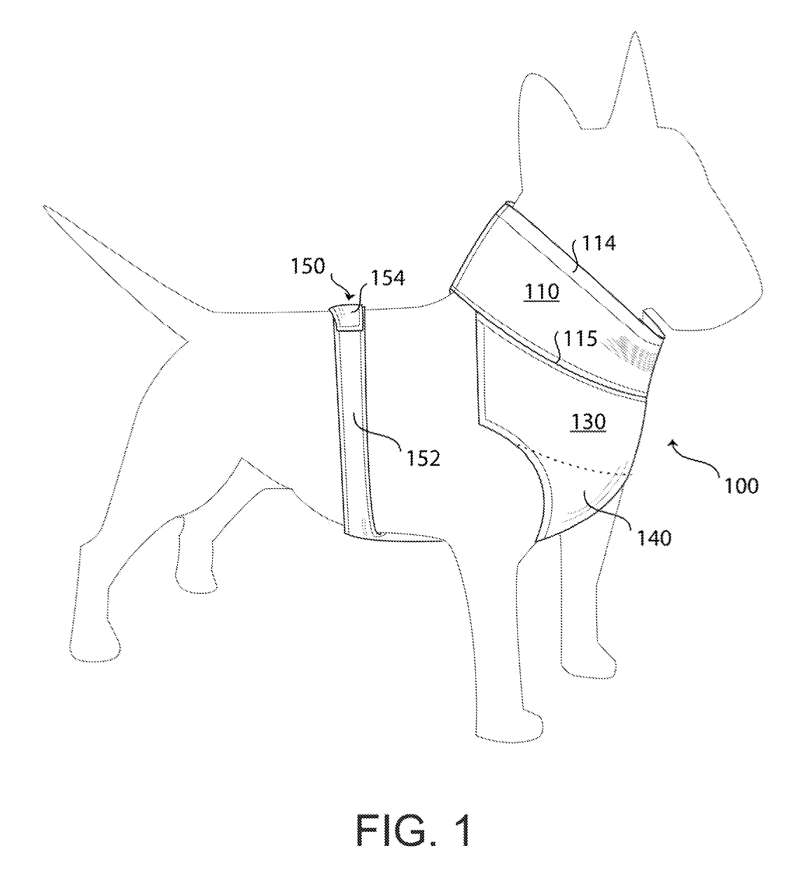

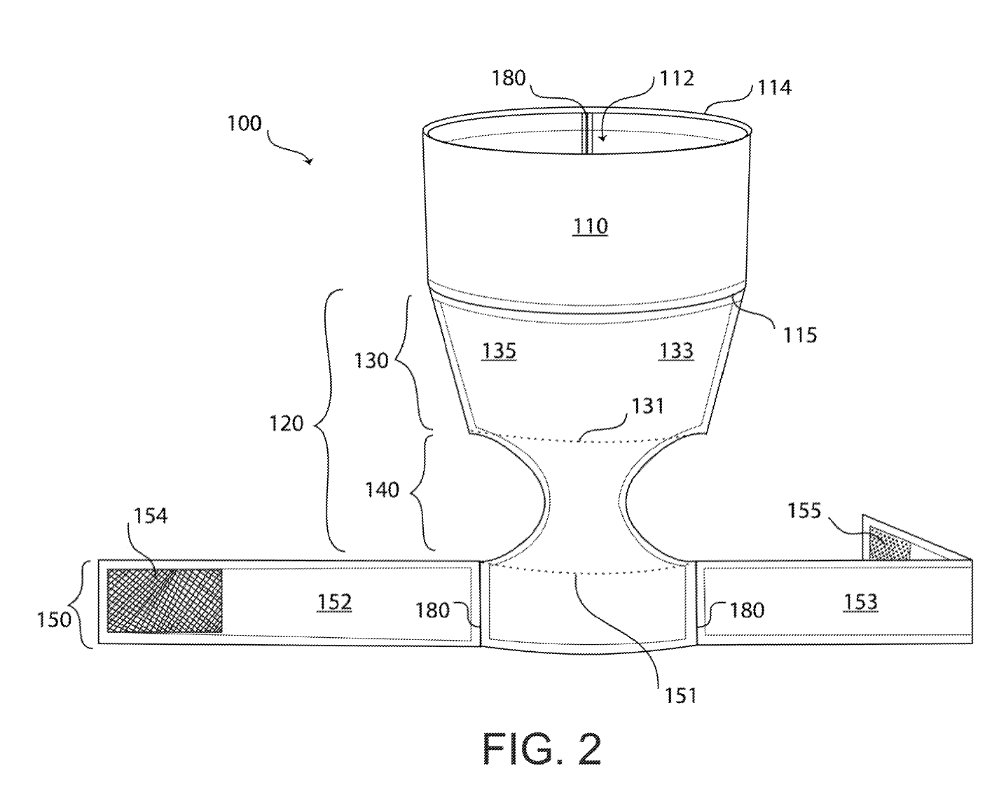

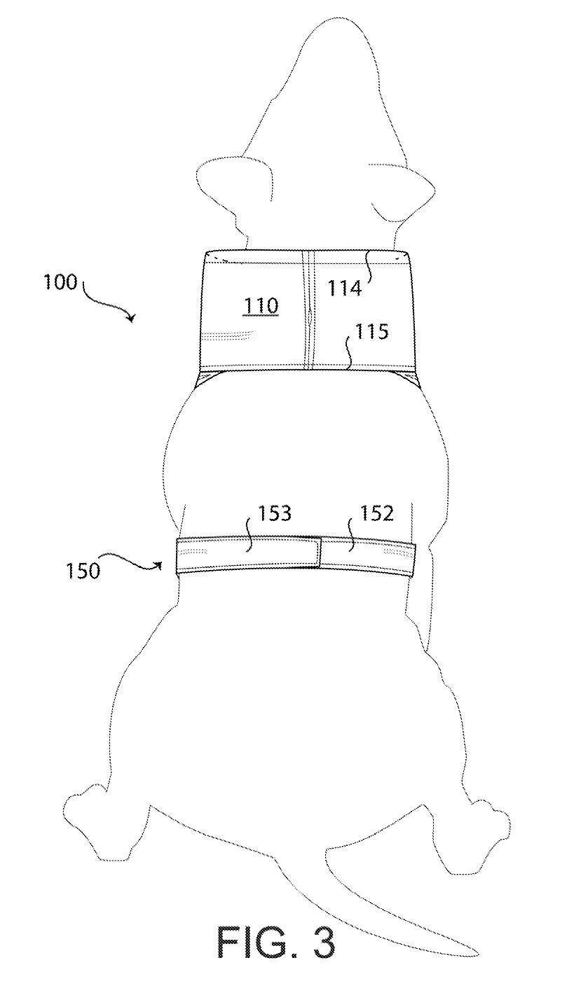

FIGS. 1-3 show a dog garment 100 in accordance with preferred embodiments of the invention, with FIGS. 1 and 3 showing a dog wearing the garment and FIG. 2 showing only the garment.

Garment 100 includes a tubular neck portion 110 having a sleeve-like opening 112 (FIG. 2) with upper 114 and lower 115 ends. Sleeve-like opening 112 is large enough to slide over a dog's head. Lower end 115 is sized sufficiently small as to be restricted from sliding posteriorly on the dog due to increasing girth of the dog, proximate the base of the neck, in the posterior direction. As used herein, and without referring to the drawings, the “base of the neck” connotes the general border along the back of the dog between the dorsal neck region and the interscapular region, along the side of the dog between the lateral neck region and the scapular region, and along the underside of the dog between the ventral neck region and the sternal region. Despite the specificity of the foregoing definition of “base of the neck,” the exact location where the lower end 115 of the neck portion 110 is stopped by increasing girth of the dog is not intended to be necessarily exactly at “the base of the neck,” but only in the general proximity to the base of the neck. The upper end 114 of the neck portion 110 preferably extends at least 75 percent of the way to the top of the dog's neck when the garment 100 is worn in normal manner by a dog. As used herein, and without referring to the drawings, the “top of the neck” connotes the general border along the back of the dog by the nape, along the side of the dog between the lateral neck region and the masteric region, and along the underside of the dog between the ventral neck (cervical) portion and the laryngeal region.

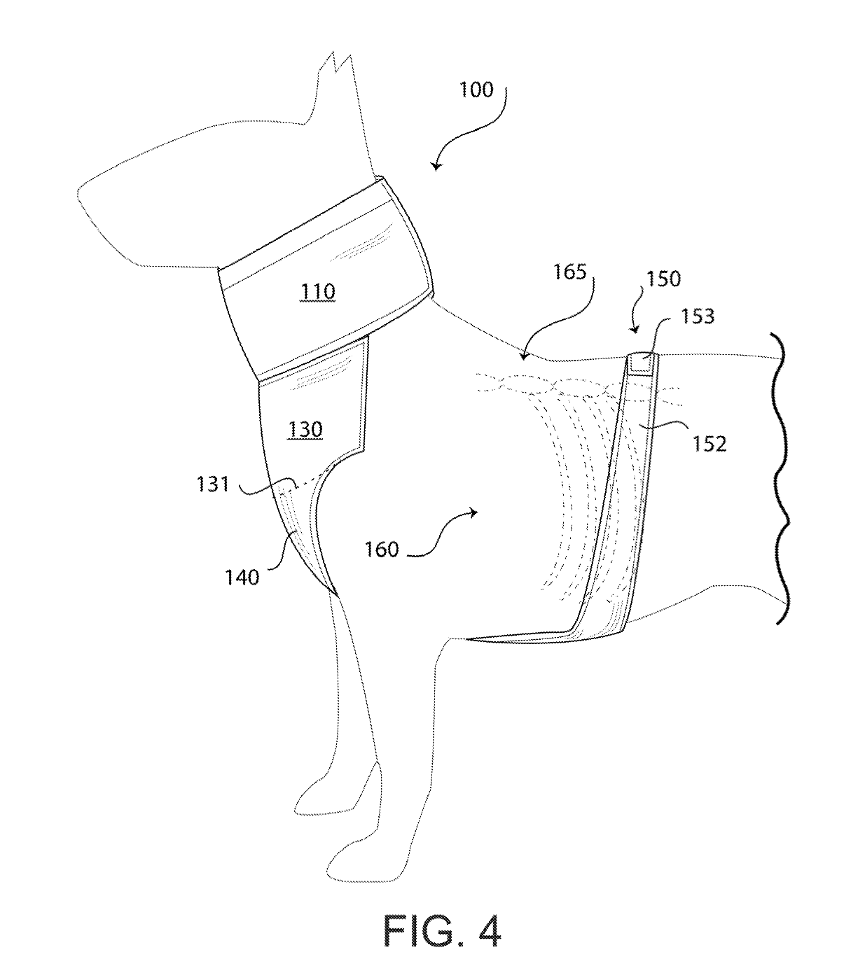

A torso portion 120 (FIG. 2) depends downwardly from the neck portion 110 and extends posteriorly on the dog to an anchoring portion 150 that preferably surrounds the sides of the rib cage of the dog in the posterior (or hindmost) section of the dog's rib cage. FIG. 4 shows this preferred relation between anchoring portion 150 and the dog's rib cage 160. This preferred relation is desirable to prevent the anchoring portion 150 of the dog garment from slipping off the posterior end of the dog, a possibility arising from the minimal amount of material and straps used for the dog garment. In particular, the rib cage 160 of the dog provides a sturdy anatomical structure to which the posterior end of the dog garment 100 can be securely anchored, in addition to the dog's spine 165. Preferably, the anchoring portion 150 is the only anchoring means for the posterior end of the dog garment.

The anchoring portion 150 includes a pair of cooperating straps 152 and 153 (FIGS. 1-4) that have cooperating attachment means, such as hooks 154 and loops 155 (FIG. 2). Many other means of attachment of straps 152 and 153 will be routine to a person of ordinary skill in the art, such as buckles or snaps. In a preferred embodiment, the anchoring portion also includes material below the phantom line 151 in FIG. 2.

As shown in FIG. 2, the torso portion 120 also includes a chest covering 130 depending downwardly from the neck portion 110 to a common vertical distance from the neck portion, marked as phantom line 131. Thus, in FIG. 2, the vertical distance from the lower end of the neck portion 115 to the lower end of the chest covering, shown by phantom line 131, is the same, or common, across the width of the chest covering. An intermediate portion 140 is situated between the chest covering 130 and the anchoring portion 150.

The intermediate portion 140 (e.g., FIGS. 1-2 and 4-5) preferably does not extend so far towards the dog's front axillae as to rub against the inner sides of the dog's front legs when the dog is walking. To this end, as shown best in FIG. 2, the left and right side edges of the intermediate portion 140, between the chest covering 130 and the anchoring portion 150, may each have a smoothly curving concave shape, from the viewpoint of an adjacent front leg of the dog, which is spaced from the dog's front axillae, when worn.

The neck 110, torso 120 and anchoring portions 150 are preferably constructed from a heat-retentive textile material such as polyester fleece, and serve to keep the dog warm with a minimal amount of material. The textile material preferably also protects the underside of the dog from injury or irritation from underbrush or the like. In FIG. 2, seams 180 and a seam at lower end 115 of the neck portion 110 may be formed by sewing together adjacent hemmed edges of material.

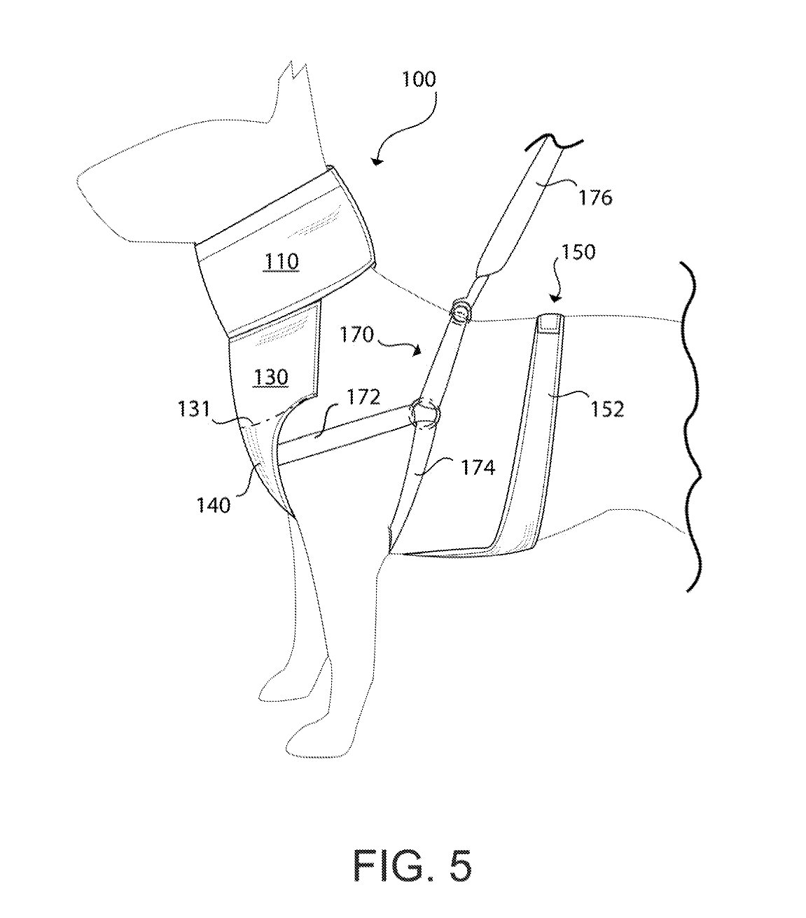

As shown in FIG. 5, in the region on the back and sides of the dog, between the neck portion 110 and the anchoring portion 150 of garment 100, the garment is preferably sufficiently free of material, so that the garment can be secured to the dog when the dog is wearing a harness 170 without interfering with operation of the harness. Harness 170 is of the type having first strap means 172 anterior and proximate to the dog's front legs and second strap means 174 posterior and proximate to the dog's front legs. The first and second strap 172 and 174 means are directly or indirectly connected to a restraining device 176 mounted on the dog's back that restrains movement of the dog. In a similar manner, the absence of material that allows use of a typical harness also allows the alternative wearing by the dog of many types of dog service vests with signage on the sides or back of the vest. Moreover, because dogs typically have a relatively substantial coat of fur on their back and sides to provide warmth, the omission of material to accommodate a harness is usually only of minor detriment, at most.

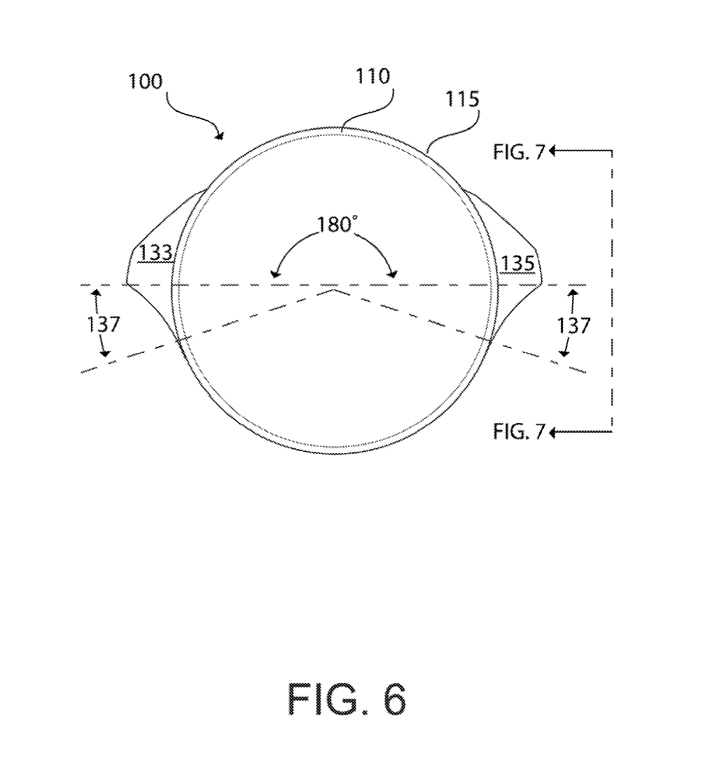

FIG. 6 shows a preferred construction of dog garment 100, with the neck portion 110 formed into an exemplary tubular shape. First lateral side 133 and second lateral side 135 of the chest covering each wraps posteriorly around a circumference of the neck portion 110, posteriorly to an anterior-facing 180 degrees of said circumference, by at least a minimum “wrap-around” angle, shown by reference numeral 137. A typical minimum wrap-around angle 137 is at least approximately 20 degrees. The term “approximately” takes into account minor deviations in the degree of the wrap-around angle, as would be readily understood by a person of ordinary skill in the art. In a preferred embodiment, a lower end 115 of the neck portion 110 is formed into an exemplary circular shape, and the foregoing circumference coincides with the lower end 115 of the neck portion 110. The lead line for reference numeral 115 extends only to the outside of the neck portion 110, because lower end 115 cannot be directly observed in FIG. 6

The present inventor has found through experimentation that wrapping the first and second lateral sides 133 and 135 posteriorly around the anteriorly facing 180 degrees creates tensile forces that bias the first and second lateral sides 133 and 135 of the chest covering inwardly towards the dog's chest area. Such tensile forces are created when the dog garment is worn in a normal manner.

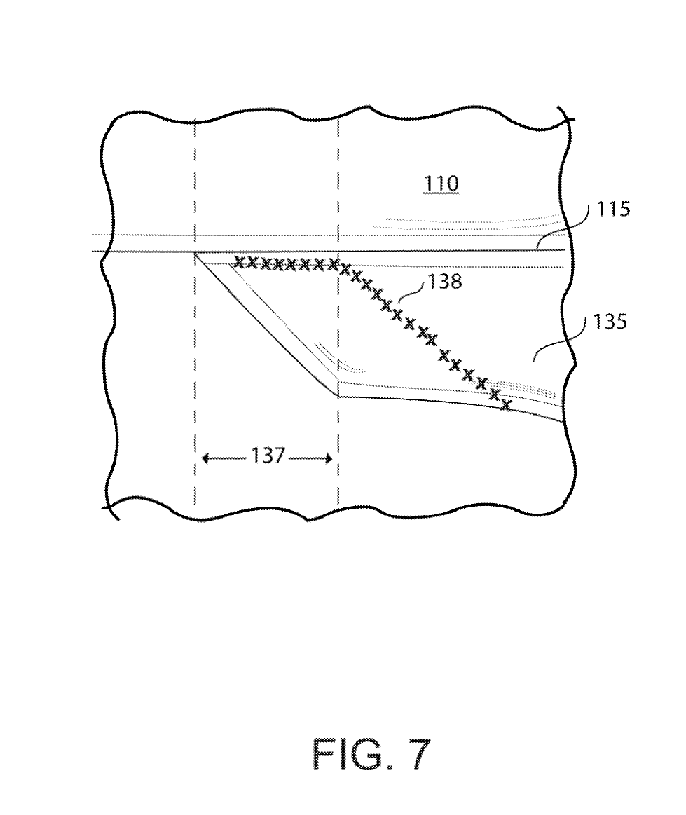

In more detail, FIG. 7 shows an approximate location of a tensile force 138 that is created due to the lateral side 135 of the chest covering wrapping posteriorly around the lower end 115 of the neck portion 110 by a wrap-around angle shown by reference numeral 137. Tensile force 138 (FIG. 7) causes first and second lateral sides 133 and 135 (FIG. 6) of the chest covering to be biased towards a dog's chest, by articulating inwardly towards the dog's chest about the tensile force 138 acting like a hinge. Beneficially, such biasing holds the preferably heat-retentive textile material against a larger area of the dog's chest than would be possible without the foregoing wrapping-around feature related to the wrap-around degrees shown at reference numeral 137 (FIGS. 6 and 7). Such biasing also improves the aesthetic appearance of the dog garment.

In one embodiment, the chest covering 130 (FIGS. 1-2 and 4-5) overlies more than 80 percent of the chest area of a dog above the dog's front legs, where the “chest area” is the area of the dog's rib cage and scapula above the dog's front legs. The term “above” connotes an orientation indicating where a dog is in a normal standing position, as shown in FIG. 1.

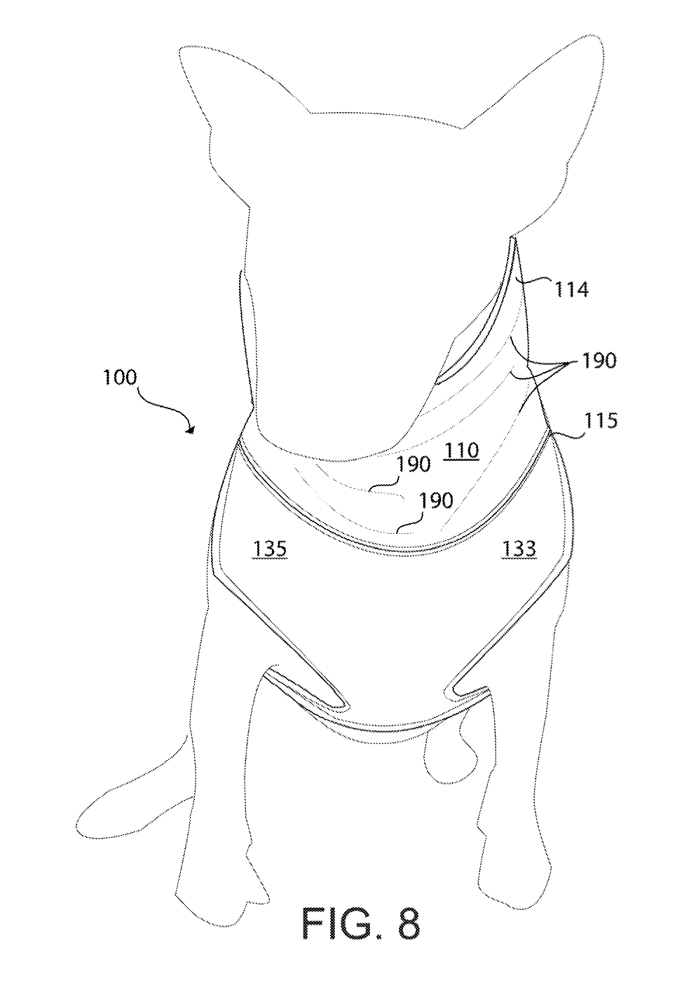

The wrap-around angle shown at reference numeral 137 in FIGS. 6 and 7 is preferably in the range of from approximately 20 degrees to approximately 50 degrees. A more preferred range is from approximately 26 degrees to approximately 46 degrees. In more general terms, the wrap-around angle as shown by reference numeral 137 (FIGS. 6 and 7) is chosen to cause the first and second lateral sides 133 and 135 (FIGS. 2 and 8 of the chest covering to be biased towards the chest of a dog. The selection of an appropriate wrap-around angle will be routine to a person of ordinary skill in the art based on the present specification.

FIG. 8 shows typical folds 190 in the neck portion 110 of the dog garment 100. In the previous figures, depiction of such folds was omitted for simplicity of illustration. The present dog garment 100 may be designed with a longer or shorter neck portion 110 to accommodate the variations in neck length and girth that occur among different breeds of dogs. Thus, the folds 190 in the neck portion 110 usually will occur on most dogs lacking long-length necks and significant neck girth, as would be readily understood by a person of ordinary skill in the art. However, even with folds 190, the neck portion 100 functions to retain body heat.

As can be seen from the above description, a preferred dog garment 100 of the present invention is constructed so that it is secured to a dog for normal use by first sliding the neck portion 100 over the dog's head and neck until the lower end 115 of the neck portion rests on the base of the neck. Then, material of the anchoring portion 150 adjacent to the torso portion 120 (FIG. 2) is moved to the posterior end of the dog's rib cage on the dog's abdomen. Finally, cooperating straps of the anchoring portion are brought up respective sides of the dog's torso and attached to each other. These are the only necessary steps to secure the preferred dog garment to a dog for normal use.

The following is a list of reference numerals and associated parts as used in this specification and drawings:

| Reference Numeral | Part |
|---|---|
| 100 | Dog garment |
| 110 | Neck portion |
| 112 | Sleeve-like opening |
| 114 | Upper end (of neck portion) |
| 115 | Lower end (of neck portion) |
| 120 | Torso portion |
| 130 | Chest covering |
| 131 | Phantom line |
| 133 | First lateral side |
| 135 | Second lateral side |
| 137 | Reference numeral (for wrap-around angle) |
| 138 | Tensile force |
| 140 | Intermediate portion |
| 150 | Anchoring portion |
| 151 | Phantom line |
| 152 | Strap |
| 153 | Strap |
| 154 | Hooks |
| 155 | Loops |
| 160 | Rib cage |
| 165 | Spine |
| 170 | Harness |
| 172 | First strap means |
| 174 | Second strap means |
| 176 | Restraining device |
| 180 | Seam |
| 190 | Folds |

While the invention has been described with respect to specific embodiments by way of illustration, many modifications and changes will occur to those skilled in the art. For instance, it will be a routine matter for a person of ordinary skill in the art to appropriately size a dog garment to fit a specific dog. It is, therefore, to be understood that the appended claims are intended to cover all such modifications and changes as fall within the true scope and spirit of the invention.

What is claimed is:

1. A dog garment for retaining body heat, comprising:
a) a tubular neck portion having a sleeve-like opening and upper and lower ends; the sleeve-like portion being large enough to slide over a dog's head; the lower end of the neck portion being sized sufficiently small so as to be restricted from sliding posteriorly on the dog due to increasing girth of the dog, proximate the base of the neck, in the posterior direction;
b) a torso portion depending downwardly from the neck portion and extending posteriorly on the dog to an anchoring portion that surrounds the sides of a rib cage of the dog in the posterior section of the dog's rib cage;
c) the anchoring portion including a pair of cooperating straps respectively extending upwardly along the sides of the dog to a device on the back of the dog for securing said straps together;
d) the torso portion having a chest covering depending downwardly from the neck portion to a common vertical distance from the neck portion and an intermediate portion situated between the chest covering and the anchoring portion;
e) the neck, torso and anchoring portions including heat-retentive textile material; and
f) in the region on the back and sides of the dog, between the neck portion and the anchoring portion, the garment being sufficiently free of material so that the garment can be secured to the dog when the dog is wearing a harness without interfering with operation of the harness, wherein the harness is of the type having a first strap means anterior and proximate to the dog's front legs and a second strap means posterior and proximate to the dog's front legs, wherein said first and second strap means are directly or indirectly connected to a restraining device mounted on the dog's back that restrains movement of the dog.

2. The dog garment of claim 1, wherein the upper end of the neck portion extends at least 75 percent of the way to the top of the dog's neck when the garment is worn in a normal manner by a dog.

3. The dog garment of claim 1, wherein the dog garment is constructed so that it is secured to a dog for normal use by—
a) first sliding the neck portion over the dog's head and neck until the lower end of the neck portion rests on the base of the neck;
b) then material of the anchoring portion adjacent to the torso portion is moved to the posterior end of the dog's rib cage on the dog's abdomen; and
c) then cooperating straps of the anchoring portion are brought up respective sides of the dog's torso and attached to each other.

4. The dog garment of claim 1, wherein the side edges of the intermediate portion, between the chest covering and the anchoring portion, each has a smoothly curving concave shape.

5. The dog garment of claim 1, wherein, when the neck portion is formed into a tubular shape, first and second lateral sides of the chest covering each wraps posteriorly around a circumference of the neck portion, posteriorly to an anterior-facing 180 degrees of said circumference, by an appropriate wrap-around angle to cause the lateral sides of the chest covering to be biased towards the chest of the dog.

6. The dog garment of claim 5, wherein the wrap-around angle is at least approximately 20 degrees.

7. The dog garment of claim 5, wherein the wrap-around angle ranges from approximately 20 degrees to approximately 50 degrees.

8. The dog garment of claim 5, wherein the wrap-around angle ranges from approximately 26 degrees to approximately 46 degrees.

9. The dog garment of claim 5, wherein the chest covering overlies more than 80 percent of the chest area of a dog above the dog's front legs.

10. The dog garment of claim 5, wherein:
a) a lower end of the neck portion is formed into a circular shape; and
b) said circumference of the neck portion coincides with the lower end of the neck portion.

11. The dog garment of claim 10, wherein the wrap-around angle is at least approximately 20 degrees.

12. The dog garment of claim 10, wherein the wrap-around angle ranges from approximately 20 degrees to approximately 50 degrees.

13. The dog garment of claim 10, wherein the wrap-around angle ranges from approximately 26 degrees to approximately 46 degrees.

14. The dog garment of claim 10, wherein the chest covering overlies more than 80 percent of the chest area of a dog above the dog's front legs.

15. The dog garment of claim 1, wherein the intermediate portion does not extend so far towards the dog's front axillae as to rub against the inner sides of the dog's front legs when the dog is walking.
